(19) United States
(12) Patent Application Publication
(10) Pub. No.: US 2014/0266569 A1
(43) Pub. Date: Sep. 18, 2014

(54) CONTROLLING MUSIC VARIABLES

(71) Applicants: Yoshinari Yoshikawa, Los Altos, CA (US); Keisuke Shingu, San Francisco, CA (US)

(72) Inventors: Yoshinari Yoshikawa, Los Altos, CA (US); Keisuke Shingu, San Francisco, CA (US)

(73) Assignee: Miselu, Inc, San Francisco, CA (US)

(21) Appl. No.: 13/842,653

(22) Filed: Mar. 15, 2013

(51) Int. Cl. G06F 3/16

(52) U.S. Cl. CPC G06F 3/165
USPC 340/4.4

(57) ABSTRACT

Embodiments generally relate to controlling music variables. In one embodiment, a system includes a processor and a hardware control device that is operable to send one or more control signals to the processor, where the one or more control signals control one or more sound variables. The system also includes a display that displays one or more dials, where the one or more dials are associated with the one or more sound variables, and where the processor causes the one or more dials to change based on the one or more control signals.

### BACKGROUND

The creation of music is a popular activity enjoyed by many people. Some music applications enable a listener to control music variables such as volume, balance, etc. For example, a music application may provide a volume slider on a touchscreen that enables a user to increase or decrease volume by placing a finger on the slider to move the slider.

### SUMMARY

Embodiments generally relate to controlling music variables. In one embodiment, a system includes a processor and a hardware control device that is operable to send one or more control signals to the processor, where the one or more control signals control one or more sound variables. The system also includes a display that displays one or more dials, where the one or more dials are associated with the one or more sound variables, and where the processor causes the one or more dials to change based on the one or more control signals.

In another embodiment, a method includes causing one or more dials to be displayed, where the one or more dials are associated with one or more sound variables. The method also includes receiving one or more control signals from a hardware control device, where the one or more control signals control the one or more sound variables. The method also includes changing one or more of the dials based on the one or more control signals.

In another embodiment, an apparatus includes one or more processors, and includes logic encoded in one or more tangible media for execution by the one or more processors. When executed, the logic is operable to perform operations including causing one or more dials to be displayed, where the one or more dials are associated with the one or more sound variables. The logic is operable to perform operations including receiving one or more control signals from a hardware control device, where the one or more control signals control one or more sound variables. The logic is operable to perform operations including changing the one or more dials based on the one or more control signals.

### BRIEF DESCRIPTION OF THE DRAWINGS

FIG. 1 is a block diagram of an example system, which may be used to implement the embodiments described herein.

FIG. 2 shows an example perspective view of a knob, which may be used to implement a control member associated with a hardware control device, according to some embodiments.

FIG. 3 shows an example top view of the knob of FIG. 2, according to some embodiments.

FIG. 4 shows an example top view of a slider, which may be used to implement a control member associated with a hardware control device, according to some embodiments.

FIG. 5 shows an example dial, according to some embodiments.

FIG. 6 shows another example dial, according to some embodiments.

FIG. 7 shows another example dial, according to some embodiments.

FIG. 8 illustrates an example simplified flow diagram for controlling music variables, according to some embodiments.

### DETAILED DESCRIPTION

Embodiments described herein enable a user to control music variables. As described in more detail below, a system enables a user to control music variables, also referred to as sound variables, using a combination of hardware elements (e.g., a physical knob) and software elements (e.g., a dial). Such sound variables may include variables such as volume, balance, reverb, pitch, tempo, effects, etc. Embodiments provide intuitive and precise control of sound variables using hardware elements. Embodiments also provide software elements, which increase flexibility and range of use of the hardware interface, and also enable efficient modification of variable inputs from the hardware elements. Such a combination of hardware elements and software elements provides optimal control of music.

As described in more detail below, the system includes a processor and a hardware control device that is operable to send one or more control signals to the processor, where the one or more control signals control one or more sound variables. The user may control the hardware control device in part via one or more physical controls referred to hereinafter as control members. Types of control members may include knobs, sliders, switches, buttons, etc. The system also includes a visual display that displays one or more virtual (software), graphical representations of dials, hereafter referred to as dials, where the one or more dials are associated with the one or more sound variables. For example, a given virtual dial may indicate volume level. The processor of the system causes the one or more dials to change based on the one or more control signals. For example, if a given control signal associated with volume causes the volume to increase, a corresponding dial showing volume level changes to indicate the increase in volume. As a result, the user is enabled to intuitively and precisely control various aspect of music.

FIG. 1 is a block diagram of an example system 100, which may be used to implement the embodiments described herein. In various embodiments, system 100 may be implemented in a musical instrument (e.g., keyboard, etc.) or in any suitable computer system (e.g., sound controller, etc.). In some implementations, system 100 may include a processor 102, an operating system 104, a memory 106, a music application 108, a network connection 110, a microphone 112, a touchscreen 114, and a speaker 116. For ease of illustration, the blocks shown in FIG. 1 may each represent multiple units. In other embodiments, system 100 may not have all of the components shown and/or may have other elements including other types of elements instead of, or in addition to, those shown herein.

Music application 108 may be stored on memory 106 or on any other suitable storage location or computer-readable medium. Music application 108 provides instructions that enable processor 102 to perform the functions described herein. In various embodiments, music application 108 may run on any electronic device including smart phones, tablets, computers, musical instruments, etc.

In various embodiments, touchscreen 114 may be separate from system 100 or integrated with system 100. For example, as shown in FIG. 1, touchscreen 114 is integrated with system 100. In some embodiments, touchscreen 114 may be separate from system 100, where touchscreen 114 is integrated with a separate device such as a tablet, computer, smartphone, etc.

In various embodiments, touchscreen 114 may include any suitable interactive display surface or electronic visual display that can detect the presence and location of a touch within the display area. Touchscreen 114 may support touching the display with a finger or hand, or any suitable passive object, such as a stylus. Any suitable display technology (e.g., liquid crystal display (LCD), light emitting diode (LED), etc.) can be employed in touchscreen 114. In various embodiments described herein, the term “touchscreen” may be used interchangeably with the term “display.” In addition, touchscreen 114 in particular embodiments may utilize any type of touch detecting technology (e.g., resistive, surface acoustic wave (SAW) technology that uses ultrasonic waves that pass over the touchscreen panel, a capacitive touchscreen with an insulator, such as glass, coated with a transparent conductor, such as indium tin oxide (ITO), surface capacitance, mutual capacitance, self-capacitance, projected capacitive touch (PCT) technology, infrared touchscreen technology, optical imaging, dispersive signal technology, acoustic pulse recognition, etc.).

In various embodiments, processor 102 may be any suitable processor or controller (e.g., a central processing unit (CPU), a general-purpose microprocessor, a micro-controller, a microprocessor, etc.). Further, operating system 104 may be any suitable operating system (OS), or mobile OS/platform, and may be utilized to manage operation of processor 102, as well as execution of various application software. Examples of operating systems include Android from Google, iPhone OS (iOS), Berkeley software distribution (BSD), Linux, Mac OS X, Microsoft Windows, and UNIX.

While processor 102 is described as performing the steps as described in the embodiments herein, any suitable component or combination of components of system 100 or any suitable processor or processors associated with system 100 or any suitable system may perform the steps described.

In various embodiments, memory 106 may be used for instruction and/or data memory, as well as to store music and/or video files created on or downloaded to system 100. Memory 106 may be implemented in one or more of any number of suitable types of memory (e.g., static random access memory (SRAM), dynamic RAM (DRAM), electrically erasable programmable read-only memory (EEPROM), etc.). Memory 106 may also include or be combined with removable memory, such as memory sticks (e.g., using flash memory), storage discs (e.g., compact discs, digital video discs (DVDs), Blu-ray discs, etc.), and the like. Interfaces to memory 106 for such removable memory may include a universal serial bus (USB), and may be implemented through a separate connection and/or via network connection 110.

In various embodiments, network connection 110 may be used to connect other devices and/or instruments to system 100. For example, network connection 110 can be used for wireless connectivity (e.g., Wi-Fi, Bluetooth, etc.) to the Internet (e.g., navigable via touchscreen 114), or to another device. Network connection 110 may represent various types of connection ports to accommodate corresponding devices or types of connections. For example, additional speakers (e.g., Jawbone wireless speakers, or directly connected speakers) can be added via network connection 110. Also, headphones via the headphone jack can also be added directly, or via wireless interface. Network connection 110 can also include a USB interface to connect with any USB-based device.

In various embodiments, network connection 110 may also allow for connection to the Internet to enable processor 102 to send and receive music over the Internet. As described in more detail below, in some embodiments, processor 102 may generate various instrument sounds coupled together to provide music over a common stream via network connection 110.

In various embodiments, speaker 116 may be used to play sounds and melodies generated by processor 102. Speaker 116 may also be supplemented with additional external speakers connected via network connection 110, or multiplexed with such external speakers or headphones.

In various embodiments, system 100 also includes hardware control device 118. Hardware control device 118 is operable to send one or more control signals to processor 102, where the one or more control signals control one or more sound variables. Such sound variables may include, for example, volume, balance, etc. In various embodiments, hardware control device 118 includes one or more physical, movable control portions or control members such as a knob, a slider, etc. Such control members are movable. For example, a control member that is a knob that can rotate. In another example, a control member that is a slider that can slide. In various embodiments, hardware control device 118 includes an electric circuit that measures physical movement (e.g., rotation of a knob, displacement of a slider or button or switch, etc.) and converts such movement into an electronic control signal.

In some embodiments, hardware control device 118 may be implemented as a peripheral device that is physically separated from system 100. For example, as shown, hardware control device 118 is integrated with system 100. In some embodiments, hardware control device 118 may be a stand-alone peripheral device with a knob, slider, etc. that operatively connects to system 100, where the connection may be a wireless or wired connection. In some embodiments, hardware control device 118 may be integrated with any other suitable device, where the other device may be a musical instrument, or music system that includes an integrated touchscreen, etc. Hardware control device 118 may or may not be integrated with the same system into which touchscreen 114 is integrated. Also, hardware control device 118 may be operatively connected to touchscreen 114 by a wireless or wired connection.

In some embodiments, control members may have multiple states (e.g., closed/collapsed state, open/deployed state, etc.). For example, a given control member may collapse to allow for a low profile when not in use, and may open (e.g., pop up, telescope up, fold up, etc. to allow for normal operation when in use).

Note that the term “hardware” in “hardware control device” indicates a control device that is a physical hardware mechanism. Also, as described in more detail below, a control member associated with hardware control device 118 may be implemented in different ways (e.g., as a knob, as a slider, etc.). Example embodiments directed to hardware control device 118 and different examples of control members are described in more detail below in connection with FIGS. 2, 3, and 4.

FIG. 2 shows an example perspective view of physical knob 200, which may be used to implement a control member associated with hardware control device 118, according to some embodiments. As shown, knob 200 is movable in that it rotates clockwise and counter clockwise in order to modulate a control signal that hardware control device 118 sends to processor 102. In various embodiments, the control signal controls one or more sound parameters based on the relative position of knob 200.

FIG. 3 shows an example top view of knob 200 of FIG. 2, according to some embodiments. As shown, in some embodiments, knob 200 has a position indicator 202 showing the positioning of knob 200 relative to position indicators 204, 206, 208, etc., where each position indicator 204, 206, 208, etc., may be associated with a different value of a sound variable. For example, in a scenario where knob 200 is controlling volume, position indicator 204 may be associated with 0 dB, position indicator 206 may be associated with 20 dB, position indicator 204 may be associated with 40 dB, etc. Accordingly, as a user rotates knob 200 clockwise, hardware control device 118 sends an appropriate control signal to processor 102 to increase the volume. These are merely example values and the particular values and measurement units assigned to the particular sound parameter will depend on the particular implementation.

As indicated above, a knob is one type of control member. Hardware control device 118 may include other types of control members such as sliders, switches, buttons, etc., and any combination thereof, depending on the particular implementation. The following example embodiments are directed to a control member that is a slider.

FIG. 4 shows an example top view of a physical slider 400, which may be used to implement a control member associated with hardware control device 118, according to some embodiments. As shown, in some embodiments, slider 400 has a position indicator 402 showing the positioning of slider 400 relative to position indicators 404, 406, 408, etc., where each position indicator 404, 406, 408, etc., may be associated with a different value of a sound variable. For example, similar to the example knob embodiments described above, slider 400 may control volume, where position indicator 404 may be associated with 0 dB, position indicator 406 may be associated with 20 dB, position indicator 404 may be associated with 40 dB, etc. Accordingly, as a user slides slider 400 from the bottom-most position corresponding to position indicator 404 toward the top-most position indicator, hardware control device 118 sends an appropriate control signal to processor 102 to increase the volume. Again, these are merely example values and the particular values and measurement units assigned to the particular sound parameter will depend on the particular implementation.

While various embodiments are described herein in the context of knobs and sliders, other types of control members are possible. For examples, hardware control device 118 may also have control members that are switches, buttons, etc., and/or any combination thereof.

In various embodiments, hardware control device 118 may include control members having various tactile features. For example, a given knob may be ribbed, knobbed, rough, etc., in order to provide the user with an intuitive tactile sense of the relative positioning of the particular control member (e.g., how much a given knob is rotated, how much a given slider is moved, etc.). In some embodiments, hardware control device 118 may include various haptic mechanisms to indicate a particular position. For example, referring again briefly to FIG. 3, knob 200 may click or snap into various positions (e.g., positions corresponding to position indicators 204, 206, 208, etc.). Such tactile features enhance a physical control member's inherent ability to enable a user to control sound parameters without having to look at the control member.

In various embodiments, touchscreen 114 displays one or more virtual dials, where such dials are associated with the one or more sound variables (e.g., volume, balance, reverb, etc.). In various embodiments, a dial is a used to display settings, measurements, and/or output representations of sound variables. Dials may be of any shape (e.g., circular, rectangular/linear, etc.), and different dials may have different combinations of shapes, depending on the particular implementations. In various embodiments, a dial is a software dial that indicates the state or states of a sound variable. Also, as described in more detail below, a dial may also function as a control in that the dial may be selected (e.g., by touch, by gesture, etc.) in order to associate the dial with a given physical control member. While some embodiments are described herein in the context of sound variables, such embodiments and others may also apply to any software variables. Examples other software variables may include lighting, stage effects such as laser lights or fog effects, etc.

In various embodiments, dials may have different markings (e.g., notches, numbers, letters, etc.), different numbers of graduations or calibrations, and different dials may have different markings, depending on the particular implementations (e.g., number of different states, resolution of state levels, units for each sound variable, etc.). As described in more detail below, in various embodiments, processor 102 causes the one or more dials to change based on the one or more control signals, which are provided by one or more control members of hardware control device 118.

In various embodiments, one or more of the dials are graphical representations of at least one control member. For example, referring to both FIGS. 3 and 5, virtual dial 500 of FIG. 5 may be a software or graphical representation of physical knob 200 of FIG. 3.

FIG. 5 shows an example dial 500, according to some embodiments. As shown, dial 500 may be a graphical (virtual) representation of physical knob 200 of FIG. 3. Dial 500 is an example of a circular dial. In this particular example, dial 500 indicates volume level using a position indicator 502.

FIG. 6 shows another example dial 600, according to some embodiments. Dial 600 may also be a graphical (virtual) representation of physical knob 200 of FIG. 3. Dial 600 is another example of a circular dial. In this particular example, dial 600 indicates balance between left and right speakers using a position indicator 602.

FIG. 7 shows another example dial 700, according to some embodiments. Dial 700 may be a graphical representation of physical slider 400 of FIG. 4. Dial 700 is an example of a rectangular or linear dial. As shown, dial 700 is oriented in a horizontal position. In some embodiments, dial 700 may be oriented in a vertical position in order to resemble physical slider 400. In various embodiments, an x-y displacement of slider 400 associated with dial 700 may cause a change in the sound variable associated with dial 700, and cause a change to dial 700 (e.g., cause a change to position indicator 702). Note that in various embodiments, any given dial may be a graphical representation of any given control member. In various embodiments, the shape (e.g., circular, rectangular, etc.) and orientation (e.g., vertical, horizontal, etc.) of a given dial may be independent of the control member to which the dial is associated. For example, dial 700 may also be a graphical representation of physical knob 200 of FIG. 3. Using a physical knob has a benefit of saving space on a console (as compared to sliders, for example). As such, a rotational change of a physical knob (e.g., knob 200) associated with dial 700 may cause a change in the sound variable associated with dial 700, and cause a change to dial 700.

Various embodiments involving the operation of the control members and dials are described in more detail below in connection with FIG. 8.

FIG. 8 illustrates an example simplified flow diagram for controlling music variables, according to some embodiments. In various embodiments, a method is initiated in block 202 where processor 102 of system 100 causes one or more dials to be displayed (e.g., in touchscreen 114), where the one or more dials are associated with the one or more sound variables.

In block 204, processor 102 receives one or more control signals from hardware control device 118, where the one or more control signals control one or more sound variables. In various embodiments, a given control member of hardware control device 118 controls one or more sound variables via control signals based on user selections that associate the given control member with one or more dials associated with such sound variables. In other words, a given control member (e.g., knob) is associated with one or more dials (e.g., volume dial) by user selection, and the given control member is hence associated with the sound parameters (e.g., volume) associated with their respective dials (e.g., volume dial). Thus, touchscreen 114 provides visual feedback of the user's tactile manipulation of the physical control member(s).

In block 206, processor 102 changes one or more of the dials based on the one or more control signals. As indicated above, hardware control device 118 has one or more control members. For example, hardware control device 118 may have a knob for controlling a sound variable such as volume. For ease of illustration, some embodiments described herein may describe a single control member. However, these and other embodiments also apply to multiple control members and multiple types of control members (e.g., knobs, sliders, switches, buttons, etc., and any combination thereof).

In various embodiments, the user may select one or more dials to be associated with a given control member. In other words, multiple dials (and corresponding sound parameters) may be associated with each control member. For example, two or more channels having two or more volume levels may be associated with (and thus controlled by) a single knob.

In various embodiments, when the user selects one or more dials, processor 102 receives the selection and then associates the selected dials with the control member that is associated with the hardware control device. As a result, the control member controls the sound parameters associated with those dials. Also, by association, the selected dials become graphical representations of the control member. When the user moves the control member (e.g., rotates a knob) to change a sound parameter (e.g., increase volume), the sound parameter changes (e.g., volume is increased) and the corresponding dial changes (e.g., visually indicates that the volume is increased). If multiple dials (e.g., multiple channels) are associated with the control member, the sound parameters associated with all such dials, and the dials, change together. Various embodiments directed to selecting particular dials to be associated with a control member are described in more detail below.

In various embodiments, the changing of dials involves processor 102 causing one or more dials to change based on a degree of movement of a control member. A visual observation of a given dial enables the user to determine the state of the sound variable in proportion to the range of values in the sound variable set. For example, if the sound variable is volume, a dial marker may denote a position that is half way through the rotation of the dial. Based on the control signal from the control member, the volume variable is set at 50% of its maximum value. For example, if the user rotates a knob 180 degrees, any corresponding/associated dial changes to show a rotation of 180 degrees. In other words, dials associated with a knob change based on the degree of rotation of the knob. Similarly, dials associated with a slider change based on the amount of movement of the slider (e.g., half way, etc.). In another example, if the sound variable is pitch, a dial marker may be rendered in multiple colors such that if one quarter of the dial is in the color denoting the variable state, then the pitch variable is set to 25% of its maximum value.

In some embodiments, knobs associated with hardware control device 118 may include absolute knobs and relative knobs. In some embodiments, an absolute knob starts at a particular value and continues to another fixed point (e.g., 360 degree rotation away or other predetermined degree of rotation). In some embodiments, a relative knob continues to increment the value it is tied too even after a full rotation (e.g., 360 degree rotation) until the variable can no longer be incremented. In various embodiments, after the point at which the variable can no longer be incremented, further rotation by the knob has no effect. In some embodiments, if the knob is rotated in the opposite direction, the variable begins to immediately change in the opposite direction (e.g., decrements).

In various embodiments, the portions of a given dial that change in response to movement of a corresponding control member may vary depending on the particular implementation. For example, in some embodiments, the dial may have a fixed scale (e.g., 1-100) with a moving pointer. In some embodiments, the dial may have a fixed pointer with a moving scale (e.g., 1-100). In some embodiments, the dial may have a digital reading (e.g., 50 dB, 70.5 dB, etc.) that changes.

In some embodiments, a given knob may have the capability of rotating infinitely clockwise or counter clockwise. This ability to rotate through multiple cycles enables an associated dial to have numerous states. For example, such a knob could be used to control volume; and a corresponding dial that displays digital numbers could be used to display a precise volume level (e.g., 0 dB-110 dB). So, for example, volume may be turned up manually with a physical knob, and then fine-tuned with the touchscreen display of the volume dial.

One of the many benefits of using a physical knob or slider, etc., of hardware control device 118 is that a physical control member provides more precision/higher resolution than a software-generated controller (e.g., touchscreen knob, slider, etc.). One reason is that a user can precisely control the amount/degree of movement of a given control member. This is more optimal than manipulating a software-generated controller with a finger, because a software-generated controller has inherent resolution limitations due to touch screen technology.

In some embodiments, there may be one control member (e.g., a single knob). Any selection of one or more dials results in the selected dials being associated with the single control member by default. Where hardware control device 118 has multiple control members (e.g., multiple knobs, multiple sliders, etc.), processor 102 may associate selected dials to a particular control member in a variety of ways. For example, in one embodiment, processor 102 may cause icons representing each control member to be displayed on touchscreen 114. Processor 102 may enable the user to select a particular control member and select one or more dials to associate as a group with that control member. For instance, a volume dial and a beats per minute (BPM) dial may be associated simultaneously with a single control member to simultaneously slow down and fade out a music track before beginning a second track.

In some embodiments, as the control member and dials are selected, processor 102 may provide a visual indicator that visually indicates which control member and dials are selected/active. This may be achieved in a variety of ways (e.g., brightness, color, size, shape, border, border color, etc.).

The following embodiments are involve example ways processor 102 enables a user to select dials (and corresponding sound variables) to be associated with a given control member. In some embodiments, processor 102 enables a user to utilize or manipulation touchscreen 114 in order to modify the sound variables impacted by hardware control device 118. Specifically, as indicated above, processor 102 enables the user to select dials, each dial corresponding to a particular sound variable.

In some embodiments, processor 102 enables the user to select using a touch and hold process. For example, the user may select a given dial by touching and holding (e.g., continual touch) the dial on touchscreen 114, where the dial is associated with the control member while the dial is touched and thus when the control member is manipulated (e.g., when a knob is rotated).

In some embodiments, processor 102 enables the user to select using a touch activation process. For example, the user may select a given dial with a single touch of the dial on touchscreen 114. Once touched, the dial becomes active and associated with the control member, even after the user stops touching the dial. In other words, a selected dial may be persistently active once selected, until deselected.

In various embodiments, processor 102 may disassociate a given dial from a control member in a variety of ways. For example, in some embodiments, processor 102 may disassociate a given dial from a control member when a different dial is touched. As indicated above, multiple dials may be associated with one control member. This may be achieved by, for example, a combination of commands (e.g., a command to select multiple dials combined with separate commands such as touches to select individual dials). In some embodiments, processor 102 may disassociate one or more dials from a knob based on receiving a predetermined user command (e.g., a deselect command). For example, this may be achieved by, for example, a combination of commands (e.g., a command to deselect multiple dials combined with separate commands such as touches to deselect individual dials).

In some embodiments, processor 102 enables the user to select using a special touch active process, where the user may select a dial on touchscreen 114 using a combination of fingers touches. For example, in one embodiment, the user may double touch a dial, touching more than one digit in association with the dial, using a specific finger or set of fingers to touch the dial, using a stylus to touch the dial, touching the dial as part of a gesture, swiping through the dial, pinching on the dial, pinching out from the dial, etc., or any combination thereof.

In some embodiments, processor 102 may use any suitable fingerprint recognition algorithm that detects touches from a particular finger. For example, in some embodiments, the touch of each finger may have a significant meaning (e.g., select, deselected, multiple select, multiple deselect, etc.).

In some embodiments, processor 102 may use any suitable 3-dimensional gesture detection algorithm and system to recognize gestures without the user needing to physically touch touchscreen 114. For example, the user may make a predetermined gesture in the air, and processor 102 may recognize commands from the gesture (e.g., select, deselected, multiple select, multiple deselect, etc.). In some embodiments, processor 102 may use voice recognition to select dials (e.g., “select,” “deselect,” etc.).

In some embodiments, processor 102 may enable the user to define parameter changes using scripting. For example, the user may rotate a knob to increase volume for one or more channels. Processor 102 may increase the volume for the one or more channels immediately concurrent with the rotation of the knob, and then automatically increase the volume for one or more of the channels after a predetermined/user-programmed number of seconds. The actually scripting is user-defined and will depend on the specific implementation.

In some embodiments, the user may change selections (e.g., select, deselect, reselect, etc.) on the fly as the user uses a control member to control sound parameters. For example, the user may jump from sound variable to sound variable (e.g., volume, pitch, reverb, etc., and any combinations thereof) without removing the fingers from the knob/slider/etc. Looking at the dials on touchscreen 114, the user can see the current state of each sound parameter and how the user's manipulation of the control member affects such states. This is particularly useful and optimal for a user working with many different sound variables. For example, a set of percussion sounds may involve different channels, each associated with a different percussion sound [e.g., bass drum, snare drum, tom drum(s), cymbal(s), etc.]. The user may select dials corresponding to any combination of sounds in real-time as music is being played, and them control each sound variable with a single control member (e.g., knob).

Embodiments described herein provide various benefits. For example, embodiments enable a user to intuitively and precisely control music variables using a physical controller such as a knob or slider. Embodiments also enable a user to conveniently see how such music variables change using one or more software indicators such as virtual dials.

Although the description has been described with respect to particular embodiments thereof, these particular embodiments are merely illustrative, and not restrictive. Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A system comprising:
a processor;
a hardware control device that is operable to send one or more control signals to the processor, wherein the one or more control signals control one or more sound variables; and
a display that displays one or more dials, wherein the one or more dials are associated with the one or more sound variables, and wherein the processor causes the one or more dials to change based on the one or more control signals.

2. The system of claim 1, wherein the hardware control device comprises at least one control member.

3. The system of claim 1, wherein the hardware control device comprises at least one control member, and wherein one or more of the dials are graphical representations of the at least one control member.

4. The system of claim 1, wherein the hardware control device comprises at least one control member, and wherein one or more of the dials change based on a degree of movement of one control member.

5. The system of claim 1, wherein the hardware control device comprises at least one control member, and wherein the processor enables multiple dials to be changed based on one control member.

6. The system of claim 1, wherein the hardware control device comprises at least one control member, and wherein the at least one control member is a knob.

7. The system of claim 1, wherein the hardware control device comprises at least one control member, and wherein the at least one control member is a slider.

8. A method comprising:
causing one or more dials to be displayed, wherein the one or more dials are associated with one or more sound variables;
receiving one or more control signals from a hardware control device, wherein the one or more control signals control the one or more sound variables; and
changing one or more of the dials based on the one or more control signals.

9. The method of claim 8, further comprising:
receiving a selection of one or more of the dials; and
associating the selected one or more dials with a control member that is associated with the hardware control device.

10. The method of claim 8, further comprising generating the one or more dials, wherein one or more of the dials are graphical representations of a control member that is associated with the hardware control device.

11. The method of claim 8, wherein the changing of the one or more dials comprises causing one or more of the dials to change based on a degree of movement of a control member that is associated with the hardware control device.

12. The method of claim 8, wherein the method further comprises enabling multiple dials to be changed based on a control member that is associated with the hardware control device.

13. The method of claim 8, wherein the hardware control device includes at least one control member, and wherein the at least one control member is a knob.

14. The method of claim 8, wherein the hardware control device includes at least one control member, and wherein the at least one control member is a slider.

15. An apparatus comprising:
one or more processors; and
logic encoded in one or more tangible media for execution by the one or more processors, and when executed operable to perform operations comprising:
causing one or more dials to be displayed, wherein the one or more dials are associated with one or more sound variables;
receiving one or more control signals from a hardware control device, wherein the one or more control signals control the one or more sound variables; and
changing the one or more dials based on the one or more control signals.

16. The apparatus of claim 15, wherein the logic when executed is further operable to perform operations comprising:
receiving a selection of one or more of the dials; and
associating the selected one or more dials with a control member that is associated with the hardware control device.

17. The apparatus of claim 15, wherein the logic when executed is further operable to perform operations comprising generating the one or more dials, wherein one or more of the dials are graphical representations of a control member that is associated with the hardware control device.

18. The apparatus of claim 15, wherein to change the one or more dials, the logic when executed is further operable to perform operations comprising causing one or more of the dials to change based on a degree of movement of a control member that is associated with the hardware control device.

19. The apparatus of claim 15, wherein the logic when executed is further operable to perform operations comprising enabling multiple dials to be changed based on a control member that is associated with the hardware control device.

20. The apparatus of claim 15, wherein the hardware control device includes at least one control member, and wherein the at least one control member is a knob.
